(19) United States
(12) Patent Application Publication
(10) Pub. No.: US 2015/0002349 A1
(43) Pub. Date: Jan. 1, 2015

(54) Radio-Frequency Device and Wireless Communication Device for Enhancing Antenna Isolation

(71) Applicant: Wistron NeWeb Corporation, Hsinchu (TW)

(72) Inventors: Yen-Chun Peng, Hsinchu (TW); Yen-Liang Wu, Hsinchu (TW); Cheng-Geng Jan, Hsinchu (TW); Guo-Cheng Tsai, Hsinchu (TW); Huang-Tse Peng, Hsinchu (TW); Chin-Jui Wu, Hsinchu (TW)

(73) Assignee: Wistron NeWeb Corporation, Hsinchu (TW)

(21) Appl. No.: 14/269,191

(22) Filed: May 4, 2014

(30) Foreign Application Priority Data
Jun. 28, 2013 (TW) 102123231

(51) Int. Cl. H01Q 21/28; H01Q 1/48

(52) U.S. Cl. CPC H01Q 21/28; H01Q 1/48
USPC 343/727; 343/848

(57) ABSTRACT

A radio-frequency device for a wireless communication device includes an antenna disposition area; a plurality of linearly polarized antennas for transmitting and receiving a plurality of radio signals, wherein the plurality of linearly polarized antennas are substantially disposed in the antenna disposition area in a manner such that polarization directions of the plurality of linearly polarized antennas are orthogonal to each other; and a grounding resonant element coupled to a grounding terminal of one of the plurality of linearly polarized antennas for enhancing isolations of the plurality of linearly polarized antennas.

### BACKGROUND OF THE INVENTION

1. Field of the Invention

The present invention relates to a radio-frequency device and a wireless communication device, and more particularly, to a radio-frequency device and a wireless communication device with multiple antennas disposed in a limited area capable of enhancing the antenna isolation while maintaining good antenna efficiency.

2. Description of the Prior Art

Electronic products with wireless communication functionalities, e.g., laptops, tablet PCs, personal digital assistants (PDAs), wireless base stations, mobile phones, smart meters, USB dongles, etc., utilize antennas to emit and receive radio waves for transmitting or exchanging radio signals, so as to access wireless networks. In order to let the users access wireless communication networks conveniently using the electronic products, the antenna bandwidth should be as broad as possible so that more communication protocols can be complied with, while the antenna size should be minimized to meet the downsizing trend of electronic products. In addition, with the evolving of wireless communication technology, a single electronic product maybe equipped with multiple sets of antennas. In the Long Term Evolution (LTE) and the wireless local network protocol IEEE 802.11n, for example, the wireless communication systems supporting Multi-input Multi-output (MIMO) communication technology or the like allow the electronic products to emit and receive radio signals by using multiple sets of antennas. In such a situation, the data throughput and the distance of transmission of the wireless communication systems are largely increased, without sacrificing the bandwidth and total transmit power expenditure of the systems. Consequently, the spectral efficiency and transmission speed of the wireless communication systems are effectively enhanced, which therefore improves the quality of communication.

As mentioned above, wireless communication products should be equipped with multiple sets of antennas in order to create parallel spatial pipes with multiple antenna patterns for realizing the MIMO communication technology. Since multiple sets of antennas are disposed on a single product, it is therefore a challenging issue to consider the interference among antennas for antenna designs.

In the prior art, multiple sets of antennas are designed to be disposed on different ends of the longest diagonal line or the longest side of the entire wireless communication product, so as to reduce the interference among the antennas and achieve preferred performance characterized by complementarity of the multiple sets of antennas. However, if the dimension of the wireless communication product is too small or the allowable antenna disposition area occupies only a relatively small part of the wireless communication product, the layout as well as the structure of the multiple sets of antennas should be considered carefully to reduce interference. Thus, additional design difficulties are raised in such antenna designs.

Therefore, how to dispose multiple sets of antennas in a limited space while ensuring that each of the antennas achieves preferred antenna efficiency and isolation so as to comply with transmission requirements is an important topic to be addressed and discussed.

### SUMMARY OF THE INVENTION

An objective of the present invention is to provide a radio-frequency device and a wireless communication device thereof capable of enhancing the antenna isolation, so as to dispose multiple sets of antennas in a small antenna disposition area and maintain good antenna efficiency.

An embodiment of the present invention discloses a radio-frequency device for a wireless communication device. The radio-frequency device includes an antenna disposition area; a plurality of linearly polarized antennas, for transmitting and receiving a plurality of radio signals, wherein the plurality of linearly polarized antennas are substantially disposed in the antenna disposition area in a manner such that polarization directions of the plurality of linearly polarized antennas are orthogonal to each other; and a grounding resonant element, coupled to a grounding terminal of one of the plurality of linearly polarized antennas for enhancing isolations of the plurality of linearly polarized antennas.

A further embodiment of the present invention discloses a wireless communication device including a radio-frequency signal processor, for processing a plurality of radio signals, and a radio-frequency device. The radio-frequency device includes an antenna disposition area; a plurality of linearly polarized antennas, for transmitting and receiving the plurality of radio signals, wherein the plurality of linearly polarized antennas are substantially disposed in the antenna disposition area in a manner such that polarization directions of the plurality of linearly polarized antennas are orthogonal to each other; and a grounding resonant element, coupled to a grounding terminal of one of the plurality of linearly polarized antennas for enhancing isolations of the plurality of linearly polarized antennas.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication device according to an embodiment of the present invention.

FIG. 2 is a schematic diagram of a radio-frequency device according to an embodiment of the present invention.

FIG. 3A is a structural diagram of a radio-frequency device according an embodiment of the present invention.

FIG. 3B is a structural diagram of a radio-frequency device according an embodiment of the present invention.

FIG. 3C is a diagram of a voltage standing wave radio (VSWR) of the radio-frequency devices shown in FIG. 3A and FIG. 3B.

FIG. 4A is a structural diagram of a radio-frequency device according an embodiment of the present invention.

FIG. 4B is a structural diagram of a radio-frequency device according an embodiment of the present invention.

FIG. 4C is a structural diagram of a radio-frequency device according an embodiment of the present invention.

FIG. 4D is a diagram of a voltage standing wave ratio (VSWR) of the radio-frequency devices shown in FIGS. 4A to 4C.

FIG. 5 is a structural diagram of a radio-frequency device according an embodiment of the present invention.

### DETAILED DESCRIPTION

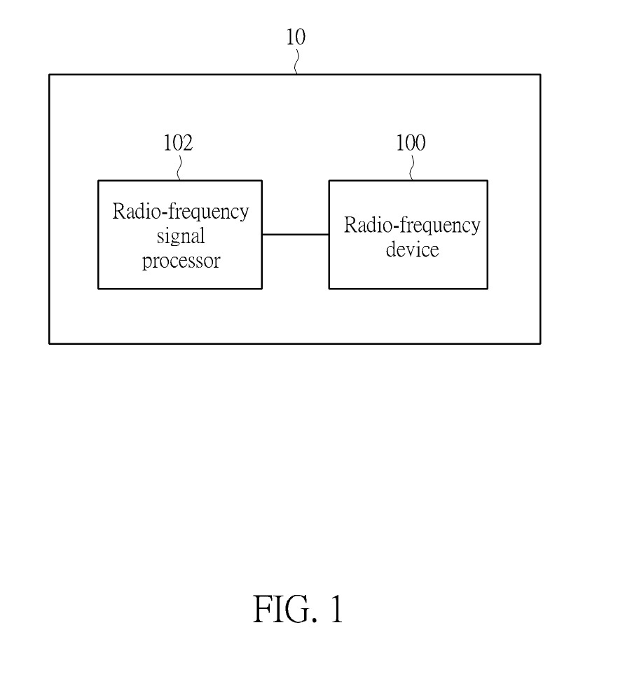

Please refer to FIG. 1, which is a schematic diagram of a wireless communication device 10 according to an embodiment of the present invention. The wireless communication device 10 may be any electronic product having wireless communication functionality such as a mobile phone, a computing system and a wireless access point. For simplicity, FIG. 1 only illustrates that the wireless communication device 10 includes a radio-frequency device 100 and a radio-frequency signal processor 102. The radio-frequency device 100 provides the wireless communication functionality of the wireless communication device 10. More specifically, the wireless communication device 10 can support simultaneously receiving or transmitting multiple wireless signals of the same frequency band, and the radio-frequency device 100 can ensure isolation under such an operation. The term “simultaneously receiving or transmitting multiple wireless signals of the same frequency band” means that a wireless communication system supporting MIMO technology, such as LTE, IEEE 802.11n, etc., simultaneously receives or transmits wireless signals, or different wireless communication systems applying the same frequency band, such as Bluetooth and Wi-Fi, simultaneously receive or transmit wireless signals.

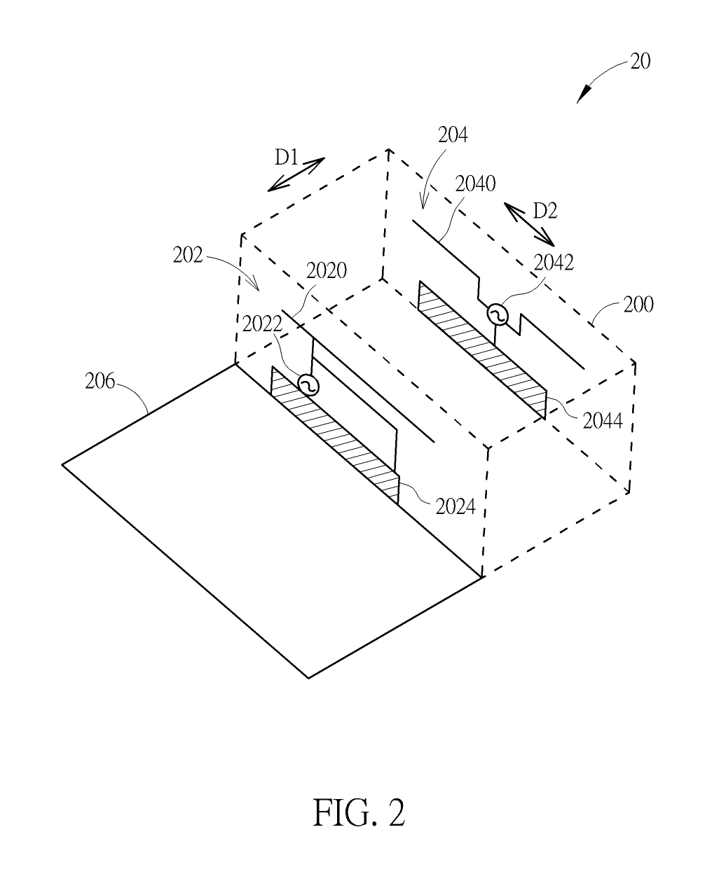

Please refer to FIG. 2, which is a schematic diagram of a radio-frequency device 20 according to an embodiment of the present invention. The radio-frequency device 20 may be used to realize the radio-frequency device 100 for the wireless communication device 10 shown in FIG. 1, but is not limited herein. As shown in FIG. 2, the radio-frequency device 20 includes a first linearly polarized antenna 202 and a second linearly polarized antenna 204 disposed in an antenna disposition area 200. In this embodiment, the antenna disposition area 200 is a three-dimensional space. The first linearly polarized antenna 202 and the second linearly polarized antenna 204 are disposed in the antenna disposition area 200 in a manner such that the polarization directions of the first linearly polarized antenna 202 and the second linearly polarized antenna 204 are orthogonal to each other for transmitting and receiving multiple wireless signals of the same frequency band simultaneously. The radio-frequency device 20 further includes a grounding resonant element 206, which is coupled to a grounding terminal 2024 of the first linearly polarized antenna 202 for enhancing isolations of the first linearly polarized antenna 202 and the second linearly polarized antenna 204, thereby achieving good antenna efficiency.

In detail, the first linearly polarized antenna 202 includes a radiating element 2020, a feed-in terminal 2022 and a grounding terminal 2024. The feed-in terminal 2022 is coupled to a radio-frequency signal processor of a wireless communication device, and the radiating element 2020 is used to emit and receive wireless signals. Similarly, the second linearly polarized antenna 204 includes a radiating element 2040, a feed-in terminal 2042 and a grounding terminal 2044, wherein the feed-in terminal 2042 is coupled to a radio-frequency signal processor of a wireless communication device and the radiating element 2040 is used to emit and receive wireless signals. As shown in FIG. 2, the first linearly polarized antenna 202 and the second linearly polarized antenna 204 are respectively disposed on two parallel planes of the antenna disposition area 200. The first linearly polarized antenna 202 is a planar inverted-F antenna. According to the positions and directions of the feed-in terminal 2022 and the radiating element 2020, the first linearly polarized antenna 202 emits and receives wireless signals having a linear polarization direction D1. On the other hand, the second linearly polarized antenna 204 is a dipole antenna. According to the positions and directions of the feed-in terminal 2042 and the radiating element 2040, the second linearly polarized antenna 204 emits and receives wireless signals having a linear polarization direction D2, which is orthogonal to the direction D1. The grounding resonant element 206 connects to the grounding terminal 2024 of the first linearly polarized antenna 202 for adjusting the impedance of the first linearly polarized antenna 202. Accordingly, the isolations of the first linearly polarized antenna 202 and the second linearly polarized antenna 204 are enhanced, so as to fulfill the requirements for simultaneously transmitting and receiving wireless signals of the same frequency band. As it is known to the skilled in the art, having antennas with good antenna isolation could reduce signal collision of a wireless communication system when wireless signals of the same frequency band are transmitted and received simultaneously. Consequently, the antenna efficiency is increased, and so is the data throughput. In addition, a resonant frequency of the first linearly polarized antenna 202 may be reduced by appropriately adjusting the structure of the grounding resonant element 206. Hence, the antenna disposition area 200 may be effectively reduced to achieve the objective of disposing multiple sets of antennas in a limited space.

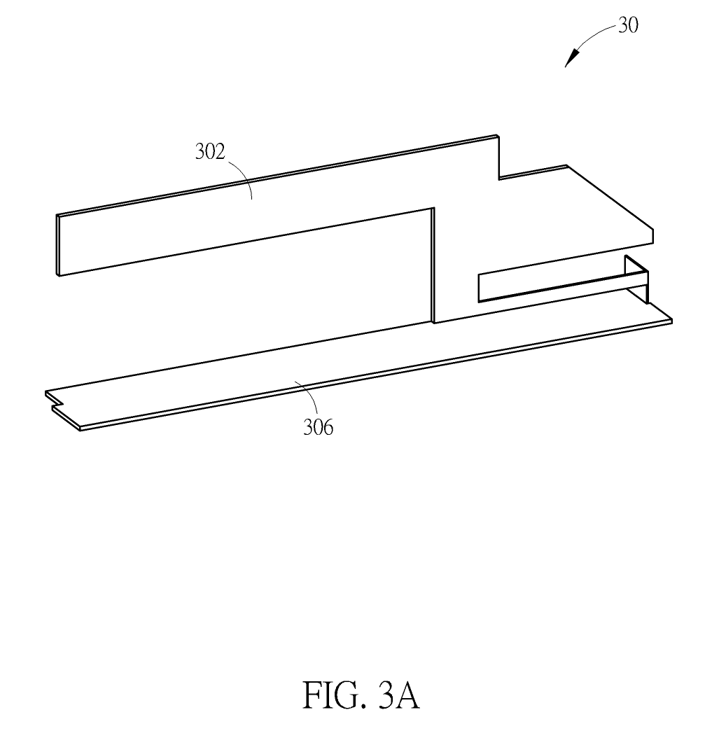

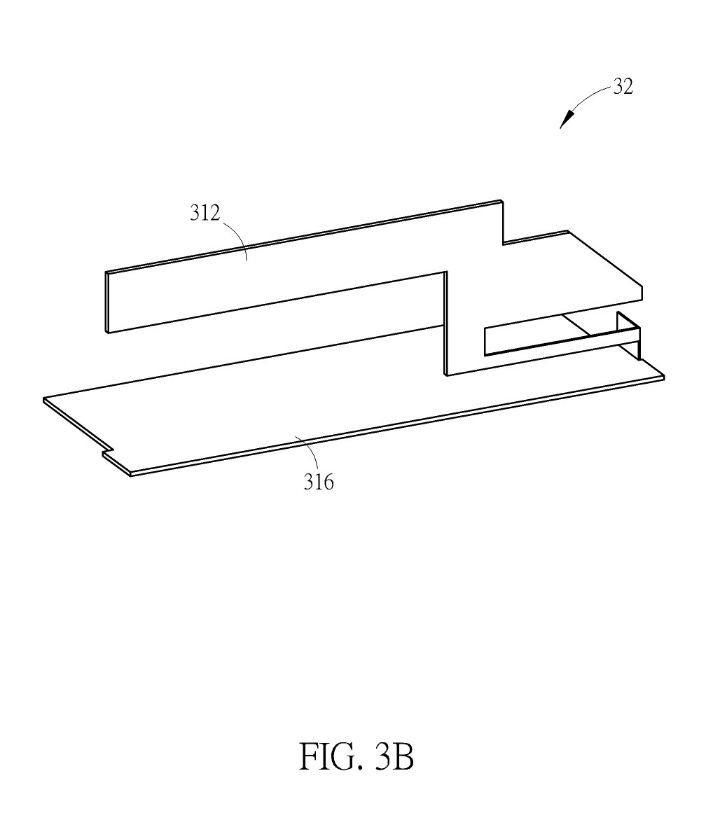

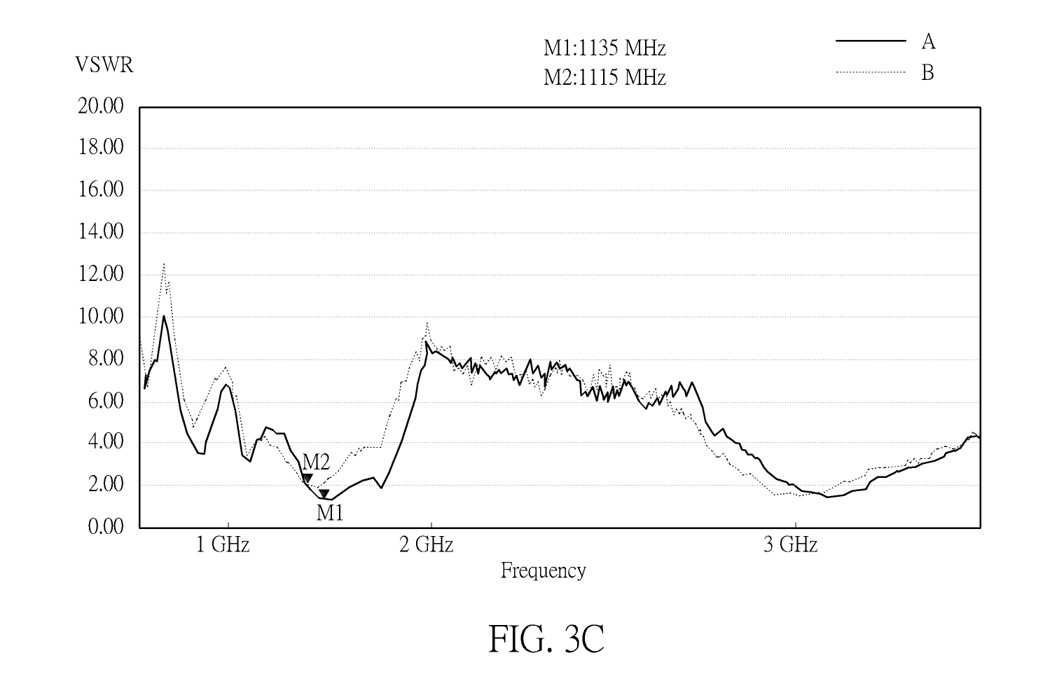

The following description illustrates the effects induced by using different structures of grounding resonant elements in a radio-frequency device. Please refer to FIG. 3A and FIG. 3B, which are structural diagrams of radio-frequency devices 30 and 32, respectively. The radio-frequency devices 30 and 32 follow the structure of the radio-frequency device 20 shown in FIG. 2. In FIGS. 3A and 3B, only the first linearly polarized antennas 302, 312 and the grounding resonant elements 306, 316 are depicted in the figures. Other elements in the radio-frequency devices 30, 32 are not shown in the figures in order to clearly illustrate the structural difference of the grounding resonant elements. The radio-frequency devices 30 and 32 are similar. The main difference between the radio-frequency device 30 and the radio-frequency device 32 is that the grounding resonant element 316 of the radio-frequency device 32 is extended lengthwise. Diagrams of the voltage standing wave ratio (VSWR) of the radio-frequency devices 30 and 32 are shown in FIG. 3C, wherein the solid line A represents the VSWR of the radio-frequency device 30 and the dotted line B represents the VSWR of the radio-frequency device 32. As shown in FIG. 3C, the length of grounding resonant element may affect the VSWR of radio-frequency device; and increasing the dimension (or the length) of the grounding resonant element reduces the resonant frequency of the first linearly polarized antenna 312, for example, from 1135 MHz to 1115 MHz.

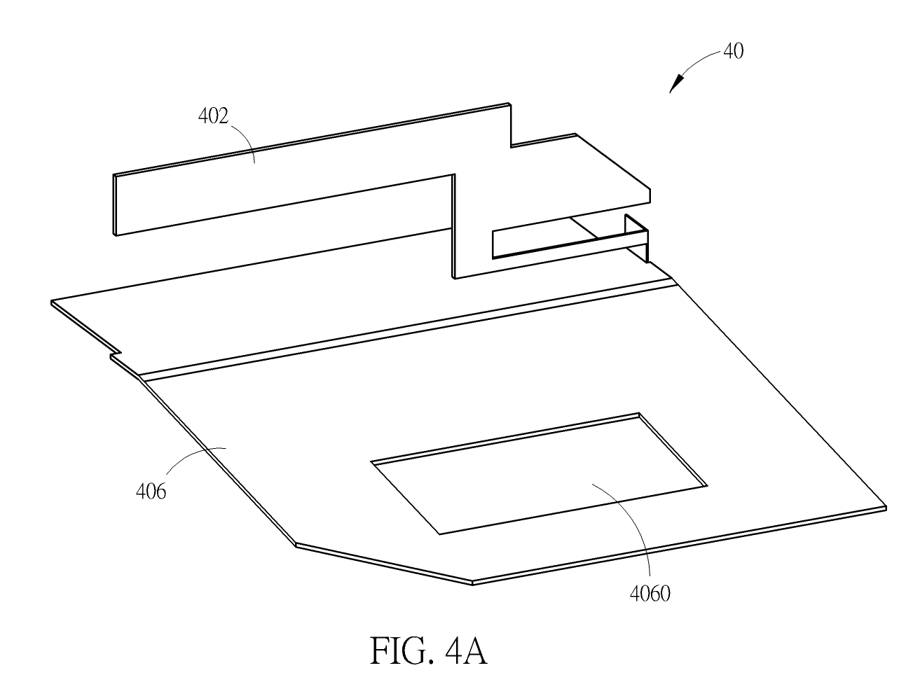

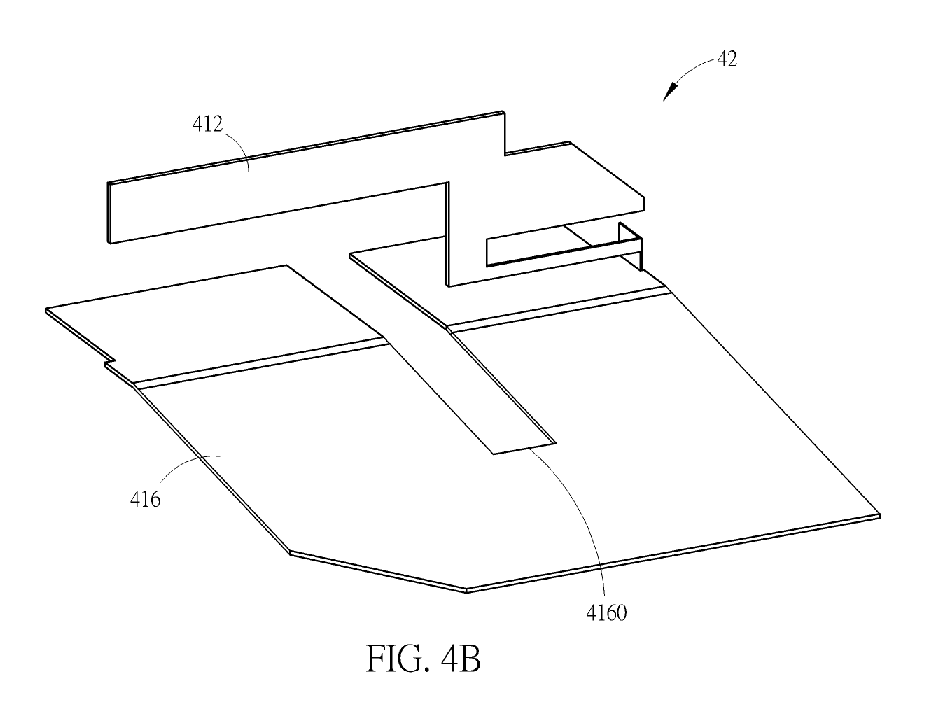

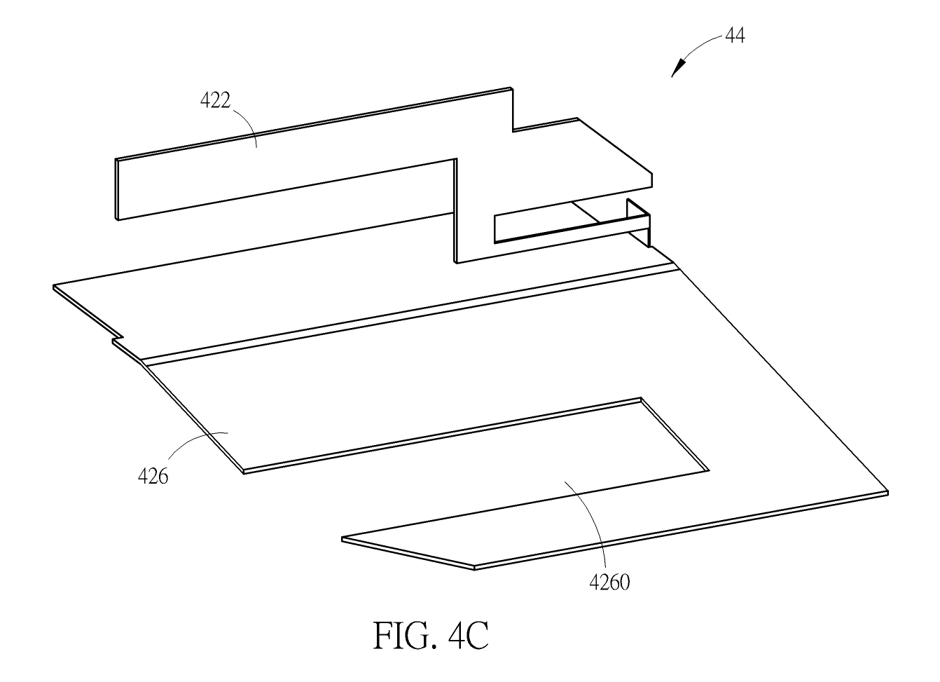

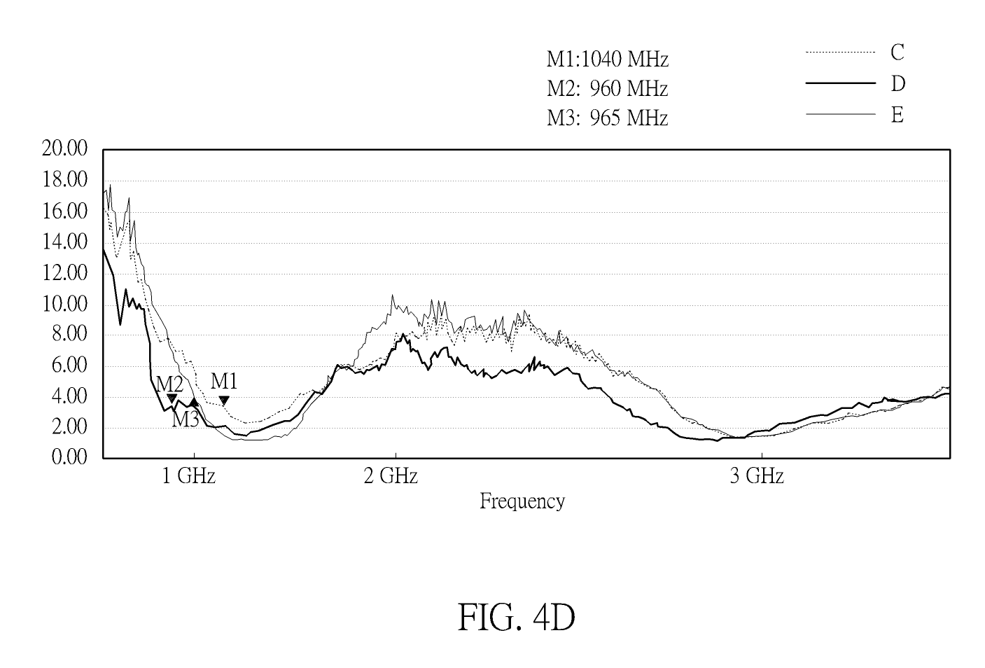

Please refer to FIGS. 4A to 4C, which are structural diagrams of radio-frequency devices 40, 42 and 44, respectively. The radio-frequency devices 40, 42 and 44 follow the structure of the radio-frequency device 20 shown in FIG. 2. In FIGS. 4A to 4C, only the first linearly polarized antennas 402, 412, 422 and the grounding resonant elements 406, 416, 426 are depicted in the figures. Other elements in the radio-frequency devices 40, 42 and 44 are not shown in the figures in order to clearly illustrate the structural difference of the grounding resonant elements. Different from the radio-frequency devices 30 and 32 shown in FIGS. 3A and 3B, the grounding resonant element 406 forms a slot 4060, the grounding resonant element 416 has a bend 4160, and/or the grounding resonant element 426 has an opening 4260. By forming the slot 4060, the bend 4160 or the opening 4260, a signal path on the grounding resonant element is elongated, which is equivalent to further extending the grounding resonant element lengthwise. Diagrams of the voltage standing wave ratio (VSWR) of the radio-frequency devices 40, 42 and 44 are shown in FIG. 4D, wherein the dotted line C represents the VSWR of the radio-frequency device 40, the thick line D represents the VSWR of the radio-frequency device 42, and the thin line E represents the VSWR of the radio-frequency device 44. As can be seen from FIG. 3C and FIG. 4D, the resonant frequency of the first linearly polarized antenna 402 is reduced to 1040 MHz by using the grounding resonant element 406 which forms the slot 4060, the resonant frequency of the first linearly polarized antenna 412 is reduced to 960 MHz by using the grounding resonant element 416 having the bend 4160, and the resonant frequency of the first linearly polarized antenna 422 is reduced to 965 MHz by using the grounding resonant element 426 having the opening 4260.

Noticeably, the present invention provides a radio-frequency device and a wireless communication device in which multiple sets of linearly polarized antennas are disposed in an antenna disposition area with their polarization directions orthogonal to each other. In addition, a grounding resonant element is provided in the radio-frequency device and the wireless communication device wherein the structure of the grounding resonant element is designed appropriately to reduce the required dimension for the linearly polarized antenna and enhance the antenna isolations among the multiple sets of linearly polarized antennas. The radio-frequency devices 20, 30, 32, 40, 42 and 44 are embodiments of the present invention. Those skilled in the art can readily make modifications and/or alternations accordingly. For example, in FIG. 2 the first linearly polarized antenna 202 is realized by a planar inverted-F antenna and the second linearly polarized antenna 204 is realized by a dipole antenna, but in other examples, antennas which are capable of inducing linearly polarized radio waves such as folded-type dipole antennas and/or slot antennas may be used to replace the first linearly polarized antenna 202 and/or the second linearly polarized antenna 204.

In addition, the abovementioned embodiments mainly use the radio-frequency device comprising two sets of antennas as the examples for illustrating the concept of the present invention (i.e. the plurality of linearly polarized antennas should be disposed in the antenna disposition area in a manner such that polarization directions of the plurality of linearly polarized antennas are orthogonal to each other, and the grounding resonant element should be added to the radio-frequency device for further enhancing the isolations). In practical, the scope of the present invention does not limit to the applications where only two sets of antennas are composed of the plurality sets of antennas. The same concept may apply to the applications where more than two sets of antennas are needed in a radio-frequency device. Moreover, the location, the orientation, the shape, and the components (e.g. the feed-in terminal) of the linearly polarized antennas in the radio-frequency device are not restricted to the abovementioned embodiments. Modifications, alternations and/or variations of the abovementioned embodiments are also within the scope of the present invention, as long as the polarization directions of the plurality of linearly polarized antennas are orthogonal to each other.

Besides, the grounding resonant element may be composed of conductive metal such as aluminum foil, copper foil, aluminum plate, copper plate, nickel silver, steel or any metal on a printed circuit board. Depending on the characteristics of the selected material, the shape of the grounding resonant element including one or more bends, slots and/or openings may be designed to form an appropriate signal path on the grounding resonant element for adjusting the impedance matching of the linearly polarized antennas. Noticeably, the dimension, the shape as well as any bend, slot and opening of the grounding resonant element may be varied and may not be on the same plane; therefore, the grounding resonant element may be formed in an available space which is needless to other elements of the radio-frequency device or the wireless communication device. For example, the grounding resonant element may be disposed in between a shell and a printed circuit board of the wireless communication device such that the dimension of the entire wireless communication device does not need to be enlarged to include the grounding resonant element.

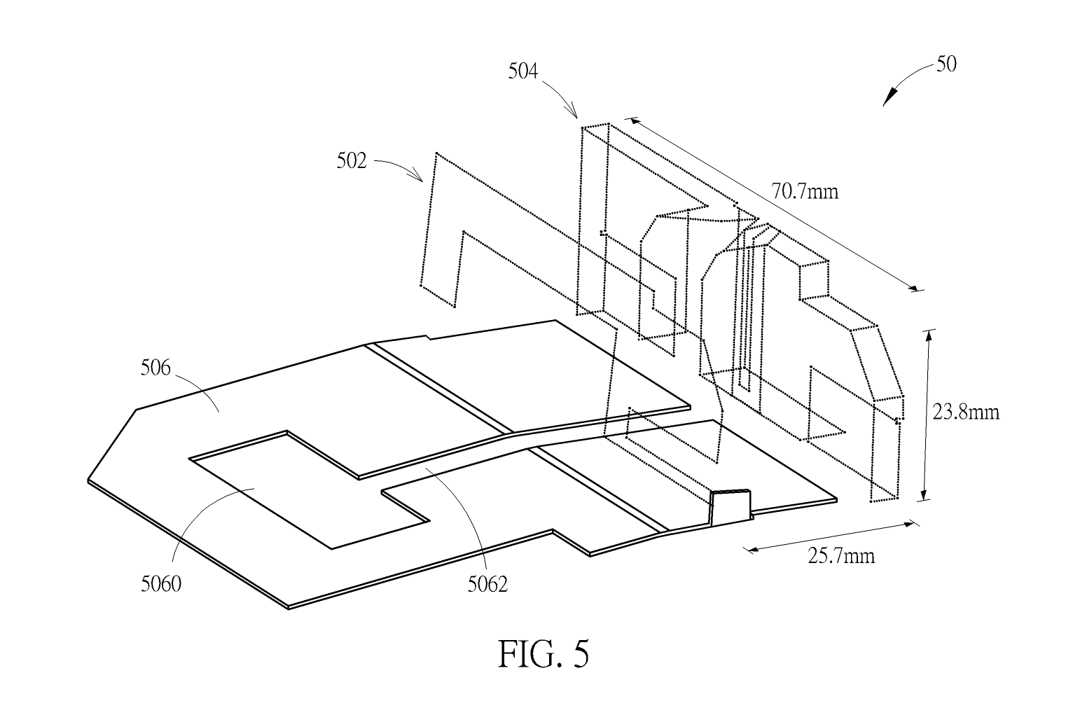

Please refer to FIG. 5, which is a structural diagram of a radio-frequency device 50 according to an embodiment of the present invention. The radio-frequency device 50 follows the structure of the radio-frequency device 20 shown in FIG. 2; therefore, it has good antenna isolation and high antenna efficiency. The radio-frequency device 50 includes a first linearly polarized antenna 502, a second linearly polarized antenna 504 and a grounding resonant element 506, and may be used in a wireless communication device. The grounding resonant element 506 forms a slot 5060 and has an opening 5062 for achieving better antenna isolation as well as accommodating the available space left in the wireless communication device. Since an operational frequency of an antenna is highly related to the dimension of the antenna's radiating elements, the dimensions of the first linearly polarized antenna 502 and the second linearly polarized antenna 504 may be adjusted appropriately based on system requirements. For example, the first linearly polarized antenna 502 and the second linearly polarized antenna 504 shown in FIG. 5 may be adjusted to comply with a millimeter-wave frequency band application such as a 3G (3^{rd} Generation) application. With appropriate structural design of the grounding resonant element 506, the first linearly polarized antenna 502 and the second linearly polarized antenna 504 may be further reduced to fit in a space of 25.7 mm×23.8 mm×70.7 mm for a 3G application. Also, good antenna isolation, high data throughput, and preferable antenna efficiency are achieved by using the radio-frequency device 50 in a wireless communication device.

To sum up, the present invention provides a radio-frequency device and a wireless communication device including the grounding resonant element for enhancing the isolations among the plurality of antennas and thus reducing signal collision of a wireless communication system. Examples of the structural design of the grounding resonant element are illustrated, since an appropriate structure of the grounding resonant element may further boost the antenna efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A radio-frequency device for a wireless communication device, the radio-frequency device comprising:
an antenna disposition area;
a plurality of linearly polarized antennas, for transmitting and receiving a plurality of radio signals, wherein the plurality of linearly polarized antennas are substantially disposed in the antenna disposition area in a manner such that polarization directions of the plurality of linearly polarized antennas are orthogonal to each other; and
a grounding resonant element, coupled to a grounding terminal of one of the plurality of linearly polarized antennas for enhancing isolations of the plurality of linearly polarized antennas.

2. The radio-frequency device of claim 1, wherein the grounding resonant element forms at least one slot.

3. The radio-frequency device of claim 1, wherein the grounding resonant element has a bend or an opening.

4. The radio-frequency device of claim 1, wherein the grounding resonant element is disposed between a shell and a printed circuit board of the wireless communication device.

5. The radio-frequency device of claim 1, wherein the plurality of linearly polarized antennas comprises a planar inverted-F antenna, a dipole antenna, a folded-type dipole antenna and/or a slot antenna.

6. A wireless communication device, comprising:
a radio-frequency signal processor, for processing a plurality of radio signals; and
a radio-frequency device, comprising:
an antenna disposition area;
a plurality of linearly polarized antennas, for transmitting and receiving the plurality of radio signals, wherein the plurality of linearly polarized antennas are substantially disposed in the antenna disposition area in a manner such that polarization directions of the plurality of linearly polarized antennas are orthogonal to each other; and
a grounding resonant element, coupled to a grounding terminal of one of the plurality of linearly polarized antennas for enhancing isolations of the plurality of linearly polarized antennas.

7. The radio-frequency device of claim 6, wherein the grounding resonant element forms at least one slot.

8. The radio-frequency device of claim 6, wherein the grounding resonant element has a bend or an opening.

9. The radio-frequency device of claim 6, wherein the grounding resonant element is disposed between a shell and a printed circuit board of the wireless communication device.

10. The radio-frequency device of claim 6, wherein the plurality of linearly polarized antennas comprises a planar inverted-F antenna, a dipole antenna, a folded-type dipole antenna and/or a slot antenna.
